(19) United States
(12) Patent Application Publication
(10) Pub. No.: US 2013/0003079 A1
(43) Pub. Date: Jan. 3, 2013

(54) PROXIMITY SENSOR CALIBRATION

(76) Inventor: Wayne T. Holcombe, Mountain View, CA (US)

(21) Appl. No.: 13/172,637

(22) Filed: Jun. 29, 2011

(51) Int. Cl. G01B 11/14

(52) U.S. Cl. 356/614

(57) ABSTRACT

Techniques are disclosed relating to proximity sensor calibration for ambient light. In one embodiment, a proximity sensor is disclosed that is configured to perform a first light measurement followed by a second light measurement followed by a third light measurement. The first and third light measurements are light measurements taken without a light source activated, and the second light measurement is taken with the light source activated. A measurement of the amount of light reflected from an object is performed based on the first, second, and third light measurements.

### RELATED APPLICATION

The present application claims the benefit of priority to U.S. application Ser. No. 12/956,775 filed Nov. 20, 2010, the disclosure of which is incorporated by reference here in its entirety.

### BACKGROUND

1. Technical Field

This disclosure relates generally to integrated circuits, and, more specifically, to proximity sensor calibration.

2. Description of the Related Art

Proximity sensors are frequently used in various applications to detect the presence of nearby objects. Proximity sensors may be included in car-parking systems (e.g., for detecting objects near a car's bumper), light switches (e.g., for turning off lights when a person is not in a room), cameras (e.g., for determining an appropriate lens focus), mobile phones (e.g., for disabling a touch screen when a user's head is close to the phone), etc. Proximity sensors typically detect objects by emitting a signal, such as an electromagnetic or electrostatic field, radiation in the form of infrared light, etc., and measuring how the signal is affected by nearby objects. Noise introduced into this signal can affect the performance of a proximity sensor. Ambient light created by the sun and other light sources such as fluorescent lights can significantly affect the performance of proximity sensors that rely on emitted light to detect the presence objects.

### SUMMARY OF EMBODIMENTS

The present disclosure describes various embodiments of structures and methods relating to proximity sensor calibration for ambient light.

In one embodiment, an apparatus is disclosed that includes a proximity sensor. The proximity sensor is configured to perform a first light measurement followed by a second light measurement followed by a third light measurement. The first and third light measurements are light measurements taken without a first light source activated. The second light measurement is taken with the first light source activated. The apparatus is configured to perform a measurement of an amount of light reflected from an object based on the first, second, and third light measurements.

In another embodiment, a method is disclosed that includes performing a proximity measurement bracketed by first and second calibration measurements. The proximity measurement measures ambient light and light generated by a first light source. The calibration measurements measure ambient light but not light generated by the first light source. The method further includes determining an amount of the generated light reflected from an object based on the proximity measurement and the calibration measurements.

In yet another embodiment, a non-transitory computer readable medium is disclosed that has program instructions stored thereon. The program instructions are executable by a processor to perform a measurement sequence that includes a first calibration measurement followed by a first proximity measurement followed by a second calibration measurement. The program instructions are further executable to cause activation of a first light source during the first proximity measurement and not during the first and second calibration measurements. The program instructions are further executable to determine an amount of light produced by the first light source and reflected from an object based on the first and second calibration measurements and the first proximity measurement.

### BRIEF DESCRIPTION OF THE DRAWINGS

FIGS. 1A and 1B are timing diagrams illustrating examples of single-calibration and dual-calibration reflectance-measurement sequences.

FIG. 2 is a block diagram illustrating one embodiment of a system that incorporates a proximity sensor.

FIG. 3 is a block diagram illustrating one embodiment of a proximity sensor.

FIG. 4 is a timing diagram illustrating one embodiment of a reflectance-measurement sequence.

FIG. 5 is a flow diagram illustrating one embodiment of a method for performing the reflectance measurement sequence.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

A proximity sensor may detect the presence of an object by emitting light, measuring the amount of emitted light that reflects back to the sensor, and determining whether the amount of reflected light has changed indicating the presence of a new object. In order to distinguish the emitted light that reflects back from ambient light, a proximity sensor may perform a reflectance-measurement sequence that includes a calibration measurement, in which ambient light is measured, and proximity measurement, in which reflected light emitted from a light source and ambient light is measured. The proximity sensor then determines the amount of reflected emitted light by subtracting the ambient light component measured in the calibration measurement from the light measured in the proximity measure.

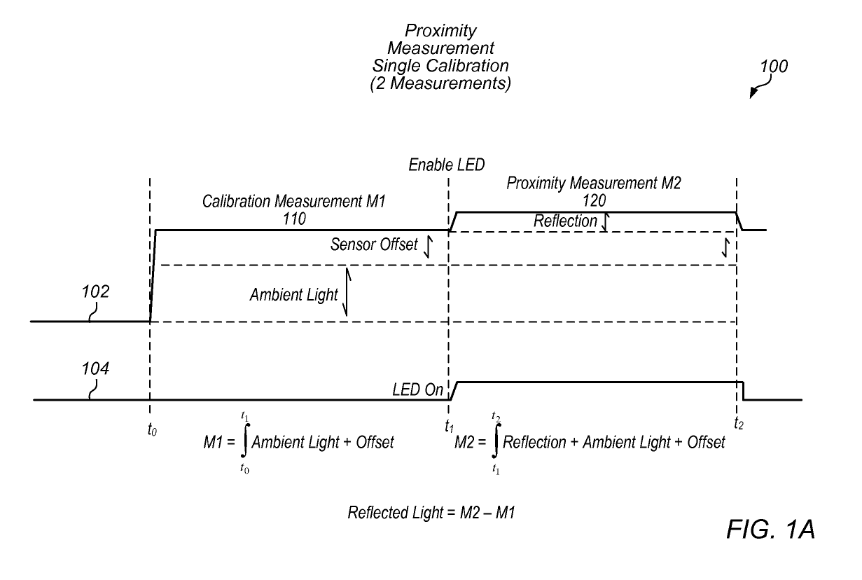

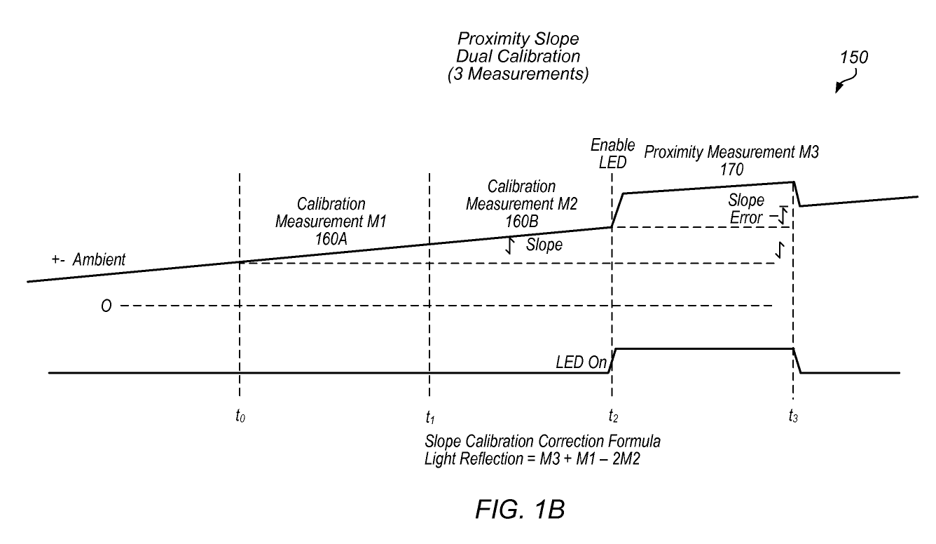

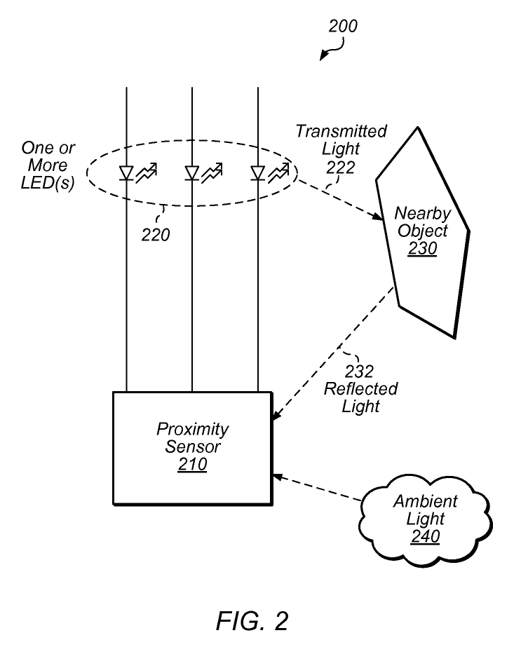

Examples of two measurement sequences that use calibration measurements are now described in conjunction with FIGS. 1A and 1B. As will be describe below in conjunction with FIGS. 2-5, the present disclosure describes embodiments of a proximity sensor that uses a measurement sequence, which, in many instances, is better at reducing ambient noise than the sequences shown in FIGS. 1A and 1B.

Turning now to FIG. 1A, a timing diagram 100 of an exemplary single-calibration measurement sequence is depicted. As shown, the measurement sequence includes a single calibration measurement 110 (also shown as M1) followed by a single proximity measurement 120 (also shown as M2). During calibration measurement 110, a proximity sensor may integrate the instantaneous light (shown by signal 102) over a period from t₀ to t₁ measuring the total integrated value to determine the amount of light for the period. The integrated measured light includes both an ambient-light component and an offset component produced by circuitry within the sensor. The proximity sensor does not activate a light source (e.g., a light-emitting diode (LED)) to emit light during measurement 110 (as indicated by LED enable single 104 being low). During proximity measurement 120, the proximity sensor activates the light source and measures the integrated light from t₁ to t₂. The measured integrated light now includes an ambient-light component, an offset component, and a reflected-light component from the light source emission. The proximity sensor may integrate the instantaneous light from t₁ to t₂ to determine the amount of light for the period. The proximity sensor may then determine the amount of reflected light by subtracting the amount of light determined in measurement 110 (e.g., the value produced from the integration from t₀ to t₁) from the amount of light determined in measurement 120 (e.g., the value produced from the integration from t₁ to t₂).

While this single-calibration measurement sequence may be able to account for static ambient light and sensor offset, any change in the ambient light caused by flicker (e.g. from folded 50 Hz to 60 Hz, which causes 100 Hz to 120 Hz AC mains modulation of incandescent or florescent lights) or flutter (e.g. rapid sunlight shadowing) between the calibration measurement and the proximity measurement can cause an error in determining the amount of reflected light. For example, if the amount ambient light is increasing over measurements 110 and 120, the proximity sensor may detect the change and attribute it to an increase in reflected light caused by the presence of a new object. A dual-calibration measurement sequence described next with reference to FIG. 1B may be less susceptible to changes in ambient light.

Turning now to FIG. 1B, a timing diagram 150 of a dual-calibration measurement sequence is depicted. This dual-calibration measurement sequence is one embodiment of a measurement sequence presented by the '775 application noted above. As shown, the measurement sequence includes a first calibration measurement 160A, a second calibration measurement 160B, and a proximity measurement 170. To determine the amount of reflected light, the amount of light measured in measurement 160B (shown as M2) may be doubled and subtracted from the sum of the amounts of light measured in measurements 160A and 170 (shown as M1 and M3, respectively)—thus, the reflected light is equal to M3+M1−2×M2. This formula assumes that calibration and reflection integration measurement periods are equal and equally spaced in time.

This measurement sequence may be more effective against ambient-light changes for instances in which the ambient-light changes occur over a longer period than the length of the measurement sequence. Use of a dual calibration period allows determining the slope of an ambient change over the periods of calibration to more accurately predict its contribution during the proximity measurement, but it assumes that the slope is relatively constant over the whole sequence. However, if changes occur over a shorter period typically due to high frequency ambient or system noise, where the changes between the calibration periods do not accurately predict the ambient during the proximity measurement period, this dual-calibration measurement sequence may actually introduce more noise than the single-calibration measurement sequence. For example, in some instances, the dual calibration measurement sequence may be about 1.414 times noisier for low-frequency uncorrelated noise than the single-calibration measurement sequence described above. This increased noise is caused by the effect of the extra calibration and noise errors on slope interpolation.

Noise signals are typically add by root mean square. This means that the noise of a single calibration measurement sequence equals \sqrt{(M2)²+(M1)²}. Assuming a unit value for RMS noise in each calibration measurement or proximity measurement, a single calibration measurement would produce a noise level of 1.414. The combined noise formula for the dual calibration is \sqrt{(M3)²+(M1)²+2×(M2)²}. Again applying a unity RMS value for each of the three measurements, this formula produces a noise level of 2, which is 1.414 times the noise level of a signal calibration measurement. (It is important to note that uncorrelated RMS noise is added even if the formula shows signals being subtracted since noise may have either a positive or negative value.) Consequently, the dual-calibration sequence may be used only for certain instances in which it improves flicker or flutter noise where the ambient change slope is relatively constant over the whole calibration and reflection measurement period.

The present disclosure describes embodiments of a proximity sensor that uses a measurement sequence that may overcome some of the above-noted shortcomings. As will be described below, in various embodiments, the proximity sensor is configured to perform a measurement sequence that includes a first calibration measurement followed by a proximity measurement followed by second calibration measurement. In various embodiments, the proximity sensor is further configured to then determine the amount of light reflected from an object based on the two calibration measurements and the proximity measurement. In one embodiment, the proximity sensor averages the amounts determined in the calibration measurements and subtracts that the average from the amount determined in the proximity measurement to determine the amount of reflected light. In some instances, bracketing the proximity measurement between two calibration measurements in this manner can reduce noise introduced by higher frequency flicker and flutter of ambient light.

Turning now FIG. 2, a block diagram of a system 200 incorporating such a proximity sensor 210 is depicted. In the illustrated embodiment, proximity sensor 210 is coupled to one or more light-emitting diodes (LEDs) 220 configured to transmit light 222 that is reflected from object 230 as light 232. In various embodiments, proximity sensor 210 is configured to identify changes in the amount of light 232 in order to determine whether a nearby object 230 is present. As noted above, changes in ambient light 240 can interfere with sensor 210's identification of changes in light 232.

In the illustrated embodiment, LEDs 220 are representative of any suitable light source that may be used by proximity sensor 210 to detect the presence of a nearby object 230 and may include light sources other than LEDs. When LEDs are used in some embodiments, LEDs 220 may include one or more infrared LEDs; in other embodiments, LEDs 220 may also include LEDs that produce visible light. In the illustrated embodiment, LEDs 220 are external to sensor 210; in other embodiments, LEDs 220 may be considered as part of sensor 210. In some embodiments, LEDs 220 may be placed in different locations around a device that includes sensor 210; in other embodiments, LEDs 220 may be in close proximity to one another. In some embodiments, LEDs 220 may have the same brightness (i.e., emit light having the same number of lumens); in other embodiments, LEDs 220 may have different respective brightnesses.

Object 230 is representative of any suitable object for which detection is desired. Object 230 may be a person or body part of a person such as a hand, finger, leg, foot, head, etc. Alternately, object 230 may be an inanimate object such as a car, parking post, wall, curb, etc.

Ambient light 240 is representative of any light produced from a source other than LEDs 220. Ambient light 240 may include sunlight, artificial light (e.g., from florescent lights powered by AC current), infrared light produced from thermal sources, etc.

In one embodiment, proximity sensor 210 is configured to reduce noise from ambient light 240 during performance of a measurement of reflected light 232 by performing a measurement sequence that includes at least one proximity measurement bracketed between at least two calibration measurements. Thus, proximity sensor 210 may perform a first calibration measurement in which LEDs 220 are disabled and proximity sensor is merely measuring an amount of light that includes ambient light 240 and any offset produced by circuitry within sensor 210 (e.g., ambient1+offset1). Proximity sensor 210 may then perform a proximity measurement in which one or more LEDs 220 are enabled and proximity sensor 210 is measuring an amount of light that includes reflected light 232 in addition to ambient light 240 and any sensor offset (e.g., reflectance+ambient2+offset2). Proximity sensor 210 may then perform a second calibration measurement in which LEDs 220 are again disabled and proximity sensor 210 is measuring an amount of light that includes ambient light 240 and any sensor offset (e.g., ambient3+offset3). In various embodiments, proximity sensor 210 is configured to determine the amount of reflected light 232 by averaging the amounts determined in the calibration measurements and subtracting that the average from the amount determined in the proximity measurement—thus, the determined reflectance=ambient2+offset2+reflectance)−(ambient1+offset1+ambient3+offset3)/2, which realizes a second-order correction for ambient light and assumes any changes in ambient light approximated by a first-order polynomial are cancelled out. Again, this formula assumes that the calibration measurements and proximity measurement have the same integration lengths and are equally spaced in time.

In many instances, this measurement sequence has less flicker and flutter noise as a well as less non-flicker and non-flutter noise than the single-calibration and dual-calibration sequences described above in conjunction with FIGS. 1A and 1B. Since the calibration measurements in this sequence are further apart than those in the previous dual-calibration sequence, the changing slope error for low-frequency ambient-light changes is less than the error of the previous dual-calibration sequence (and even lesser than the error for the single-calibration sequence). For higher frequency noise, the two calibration measurements may be averaged, which can reduce noise of their contributions to, for example, 0.707 of a single calibration since uncorrelated noise sums with root mean square unlike signals, which add linearly. Specifically, the noise formula for the bracket calibration is

$$\sqrt{{( \frac{\sqrt{{( M 1 )}^{2} + {( M 3 )}^{2}}}{2} )}^{2} + {( M 2 )}^{2} .}$$

Assuming a noise level of 1 for each measurement, this formulate gives a noise level of 1.225, which is less than the previous single calibration sequence noise level of 1.414 and less than the previous dual calibration noise level of 2 by a factor of 1.633. Consequently, it is also 1/(1.633) or has high-frequency-noise level of 0.6124 relative to the previous dual-calibration sequence.

In some embodiments, proximity sensor 210 may be configured to perform a measurement sequence that includes multiple proximity measurements bracketed between calibration measurements. For example, in one embodiment, sensor 210 may perform a measurement sequence of seven measurements that includes three proximity measurements P1, P2, and P3, bracketed by four calibration measurements C1, C2, C3, C4—namely, a sequence of C1, P1, C2, P2, C3, P3, C4. Proximity sensor 210 may perform a measurement of reflected light by averaging the amounts measured in P1-P3, averaging the amounts measured in C1-C4, and subtracting the average for C1-C4 from the average for P1-P3. In some embodiments, proximity sensor 210 may use the same calibration measurement for separate measurement sequences. For example, a proximity sensor may perform measurements C1, P1, C2, P2, C3, where C1, P1, and C2 are part of a first measurement sequence and C2, P2, and C3 are part of a second measurement sequence.

In some embodiments, proximity sensor 210 may also use different ones of LEDs 220 for different measurement sequences. As discussed above, LEDs 220 in different sequences may be located in different locations and/or have different respective brightnesses. In some embodiments, proximity sensor 210 may even use different ones LEDs for different proximity measurements within the same measurement sequence. For example, sensor 210 may use a first LED 220 during a proximity measurement P1 a second different LED 220 during a subsequent proximity measurement P2, a third different LED 220 during a final proximity measurement P3 for a measurement sequence.

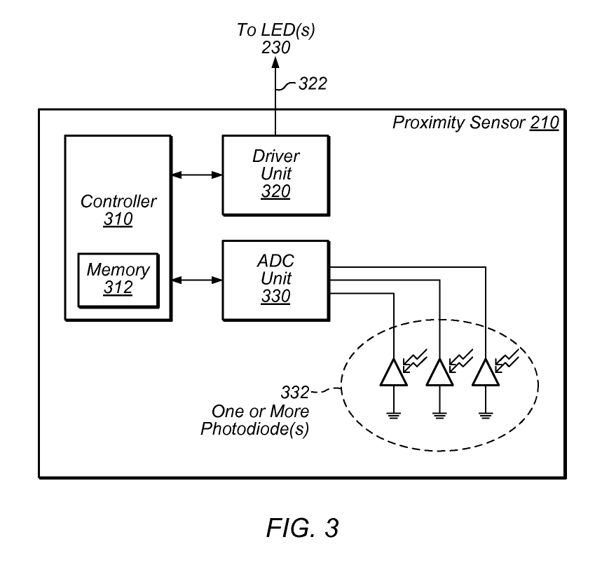

Turning now to FIG. 3, one embodiment of proximity sensor 210 is depicted. In the illustrated embodiment, proximity sensor 210 includes a control unit 310, driver unit 320, analog-to-digital converter (ADC) unit 330, and one or more photodiodes 332 (in some embodiments, photodiodes 332 may not be consider as part of sensor 210; in some embodiments, photodetectors other than photodiodes may be used).

Control unit 310, in one embodiment, is configured to control operation of proximity sensor 210 including coordinating performance of measurement sequences using units 320 and 330. In some embodiments, control unit 310 includes logic that implements one or more state machines and timers usable to manage operations of sensor 210. In the illustrated embodiment, control unit 310 is configured to execute instructions stored in memory 312 to facilitate management of sensor 210. Memory 312 is one example of a computer readable medium that stores executable instructions. Generally speaking, a computer readable medium may include any non-transitory tangible storage media readable to provide instructions and/or data. For example, a computer readable medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Accordingly, in some embodiments, a computer readable medium (such as memory 320) may have program instructions stored thereon that are executable to perform the measurement sequence described herein.

Driver unit 320, in one embodiment, is configured to provide power 322 to LEDs 220 to cause them to emit light 222. In one embodiment, control unit 310 is configured to instruct driver unit 320 to enable one or more LEDs 220 during performance of a proximity measurement. In some embodiments, control unit 310 may also select the particular LEDs 220 that are to be enabled.

ADC unit 330, in one embodiment, is configured to process the analog signal produced by one or more photodiodes 332 in response to receiving ambient light 240 during calibration measurements and receiving reflected light 232 and ambient light 240 during proximity measurements. In various embodiments, ADC unit 330 samples the analog signal with one or more ADCs that include one or more integrators to process the signal and accumulate a value indicative of the amount of light measured during a calibration or proximity measure. Embodiments of a second-order sigma-delta ADC that may be included in ADC unit 330 are described in the '775 application mentioned above. In some embodiments, control unit 310 may be configured to further process the digital values produced by ADC unit 330 to identify whether a nearby object 130 is present. In some embodiments, additional processing may, alternatively, be performed by circuitry external to proximity sensor 210 (e.g., circuitry within an apparatus that also includes proximity sensor 210).

In various embodiments, control unit 310 may be configured to adjust the integration periods of integrators in ADC unit 330 to control the length of each light measurement (i.e., calibration measurement or proximity measurement). In some embodiments, control unit 310 is configured to set these integration periods so that sensor 210 performs light measurement having a period within the range of 10 μs to 50 ms (in one embodiment, a smaller range of 10 μs to 50 μs may be used). In one particular embodiment, a period of 25.6 is may be used (sensor 210 may perform light measurements for longer or shorter periods than this range in other embodiments). In many instances, this relatively short time for performing a calibration or proximity measurement provides relatively high immunity to flicker and sunlight flutter due to the relatively low rate of change of both of these light noise sources. For example, with incandescent flicker noise, the maximum rate of change may occur on the center slope of the 120 Hz cycle and may be about 1.25% of the peak-to-peak value over a 25.6 μs interval or about 0.125% of the average value (since the incandescent peak-to-peak flicker noise is typically about 10% of the average value). With a 25.6 μs period, a 400 Lux incandescent ambient-light source may produce a flicker noise current of 288 pA in some instances. This amount of noise can be an eighty-fold improvement over a 23 nA current produced for a longer 5 ms integration period (100 Hz bandwidth), and about an 8-fold improvement over using a 50 ms integration period. Due to the shorter integration period of, for example, 25.6 μs, or an equivalent higher bandwidth of, for example, 20 KHz, the integrated shot noise may be higher, in some embodiments, at 38 pA than the 2.7 pa in the 100 Hz bandwidth example.

In some embodiments, control unit 310 is configured to adjust the lengths of calibration and proximity measurements based on the amount of ambient light being measured. In one embodiment, for lower light conditions, control unit 310 may be configured to reduce the clock signal provided to ADC unit 330 in order to extend the total integration time and thus light measurement period. This extension may be warranted when both shot and other noise sources are less than the ADC digitizing noise; the RMS value is typically about half the minimum resolution. By extending the integration period (e.g., by slowing the clock), more light samples are gathered, but the sampling rate remains the same. Typically, the 25.6 μs integration period might be extended by, say, up to 256 times, or to 6.55 ms. This gives a linear increase in signal-to-noise with increasing integration time, rather than a square root increase, if the shot noise is less than the ADC digitizing noise. Once the shot noise exceeds the digitizing noise, as the pulse width is increased, the integrated signal-to-noise will increase with the square root of the period. Note that extending the proximity measurement period increases total power but, beyond a range of, say, several meters, the measurement period can be typically ten times longer, on the order of 500 ms or more, since at these ranges the application is usually to detect body or object bulk motion, rather than, for example, faster hand commands.

In many instances, increasing the calibration and proximity measurement periods for lower light conditions is simpler and produces better signal to noise than averaging shorter periods as long as the ambient level is low enough that its shot noise contribution is less than the ADC noise floor. However, increased integration period may also decrease flicker and flutter signal to noise since the time between calibration and reflectance measurement increases proportionally to the sensitivity increase. Therefore, it may become more important to use a dual calibration mode to reject flicker and flutter noise. Consequently, it may be desirable to use the improved bracket calibration in long-range instances with high integration periods, which may, in certain instances, have 2× better flicker noise signal to noise than the use of a dual-calibration measurement sequence.

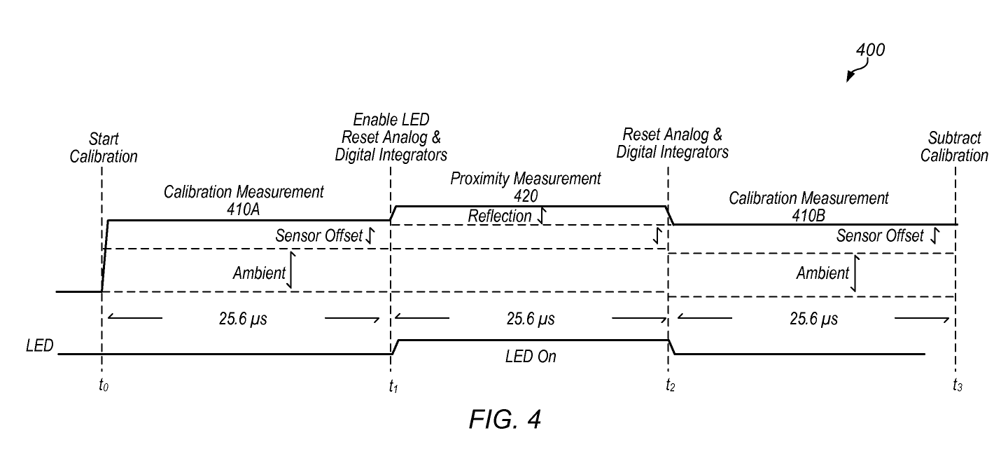

Turning now to FIG. 4, a timing diagram 400 of a measurement sequence in which a proximity measurement is bracketed by two calibration measurements is depicted. In the illustrated embodiment, proximity sensor 210 begins performing the sequence by initially performing calibration measurement 410A in which sensor 210 measures an amount of light that includes ambient light 420 and a sensor offset for 25.6 μs. Proximity sensor 210 then performs proximity measurement 420 for another 25.6 μs in which it measures an amount of light including ambient light 420, a sensor offset, and reflected light 232 produced by one or more LEDs 220. Proximity sensor concludes the measurement sequence by performing calibration measurement 410B in which it again measures ambient light 240 and any sensor offset for a final 25.6 μs. In certain embodiments, the proximity measurement can be said to “immediately” follow and precede the first and second calibration measurements within the measurement sequence, although a “real-world” proximity sensor device may have some small delay between the end of the first calibration measurement and the beginning of the proximity measurement, and between the end of the proximity measurement and the beginning of the second calibration measurement.

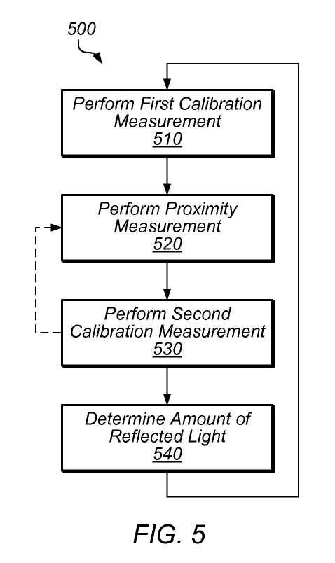

Turning now to FIG. 5, a flow diagram of a method 500 for the measurement sequence described above is depicted. Method 500 is one embodiment of a method that may be performed by a proximity sensor such as sensor 210. In the illustrated embodiment, method 500 includes 510-540. In some embodiments, 520 and 530 may be repeated to perform a longer measurement sequence (as indicated with a dotted line). Method 500 may also be performed again each time proximity sensor 210 performs a measurement of an amount of reflected light. In many instances, performance of method 500 can reduce flicker and flutter noise produced by ambient light when performing a proximity sequence.

In 510, proximity sensor 210 performs a first calibration measurement. As discussed above, this measurement is a measurement of ambient light and taken without a light source such as LEDs 220 being activated. In some embodiments, this measurement (and the other measurements in 520 and 530) may be performed for a period of (e.g., have an integration period of) 10 μs to 50 μs. In some embodiments, sensor 210 may adjust this period based on the amount of ambient light (e.g., detected during a previous performance of method 500).

In 520, proximity sensor 210 performs a proximity measurement. As discussed above, this measurement is a measurement of reflected light (such as light 232) and ambient light (e.g., light 240). In various embodiments, 520 includes activating one or more light sources (e.g. LEDs 220) to generate the light, which is reflected and measured. In some embodiments, these light sources may produce non-visible light such as infrared light.

In 530, proximity sensor 210 performs a second calibration measurement. As discussed above, this measurement is another measurement of ambient light (e.g., light 240) and is taken without the light source in 520 being activated. In various embodiments, 530 is performed in a similar manner as 510. As noted above, in some embodiments, 520 and 530 may be repeated one or more times before proceeding to 540 (in some embodiments, sensor 210 may use different light sources during subsequent performances of 520.)

In 540, proximity sensor determines an amount of reflected light (e.g. light 232) based on the measurements performed in 510-530. In various embodiments, 540 includes averaging the amounts of light determined 510 and 530 (and averaging the amounts of light determined in 520 if multiple instances of 520 have been performed) and subtracting the average amount for 510 and 530 from the amount of light determined in 520 (or the average amount for 520).

In various embodiments, sensor 210 may repeat performances of method 500 to continually detect the presence of objects 230. As noted above, in some embodiments, sensor 210 may use different light sources and/or different photodetectors during subsequent performances of method 500.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
a proximity sensor configured to perform a first light measurement followed by a second light measurement followed by a third light measurement, wherein the first and third light measurements are light measurements taken without a first light source activated, and wherein the second light measurement is taken with the first light source activated;
wherein the apparatus is configured to perform a measurement of an amount of light reflected from an object based on the first, second, and third light measurements.

2. The apparatus of claim 1, wherein the proximity sensor is configured to perform a fourth light measurement after the third light measurement and a fifth light measurement after the fourth light measurement, wherein the fourth light measurement is taken with the first light source activated, and wherein the fifth light measurement is taken without the first light source activated; and
wherein the measurement of the amount of the reflected light is based on an average amount of light determined from the first, third, and fifth light measurements.

3. The apparatus of claim 1, further comprising:
the first light source; and
a second light source;
wherein the proximity sensor is configured to perform a fourth light measurement after the third light measurement and a fifth light measurement after the fourth light measurement, wherein the fourth light measurement is taken with the second light source activated, wherein the fifth light measurement is taken without the second light source activated; and
wherein the apparatus is configured to perform a subsequent measurement of the amount of light reflected from the object based on the fourth and fifth light measurements.

4. The apparatus of claim 3, further comprising:
at least three light sources;
wherein the apparatus is configured to perform at least three measurements of an amount of light reflected from the object, wherein each of the least three measurements uses a different respective one of the at least three light sources.

5. The apparatus of claim 1, wherein the proximity sensor is coupled to at least three photodetectors; and
wherein the apparatus is configured to perform at least three measurements of an amount of light reflected from the object, wherein each of the least three measurements uses a different respective one of the at least three photodetectors.

6. The apparatus of claim 1, wherein the respective periods of the first, second, and third light measurements are between 10 μs and 50 μs.

7. The apparatus of claim 1, wherein the proximity sensor is configured to adjust the respective periods of the first, second, and third light measurements based on an amount of ambient light.

8. The apparatus of claim 1, wherein the first light source is configured to generate infrared light.

9. A method, comprising:
performing a proximity measurement bracketed by first and second calibration measurements, wherein the proximity measurement measures ambient light and light generated by a first light source, and wherein the calibration measurements measure ambient light but not light generated by the first light source; and
determining an amount of the generated light reflected from an object based on the proximity measurement and the calibration measurements.

10. The method of claim 9, wherein said determining includes averaging amounts of light measured in the first and second calibration measurements to produce an average amount and subtracting the average amount from an amount of light measured during the proximity measurement to determine the amount of the generated, reflected light.

11. The method of claim 9, further comprising:
performing a subsequent proximity measurement bracketed by the second calibration measurement and a third calibration measurement, wherein a second light source is used during the subsequent proximity measurement;
determining a subsequent amount of reflected light based on the subsequent proximity measurement and the second and third calibration measurements.

12. The method of claim 9, wherein a first photodetector is used during the proximity measurement and the first and second calibration measurements, and where the method further comprises:
using a second photodetector during a subsequent proximity measurement and two calibration measurements.

13. The method of claim 9, further comprising:
adjusting a period of a proximity measurement based on a detected amount of ambient light.

14. The method of claim 9, wherein the first light source is enabled during the proximity measurement for a period between 10 μs and 50 μs.

15. A non-transitory computer readable medium having program instructions stored thereon, wherein the program instructions are executable by a processor to:
perform a measurement sequence that includes a first calibration measurement followed by a first proximity measurement followed by a second calibration measurement;
cause activation of a first light source during the first proximity measurement and not during the first and second calibration measurements; and
determine an amount of light produced by the first light source and reflected from an object based on the first and second calibration measurements and the first proximity measurement.

16. The computer readable medium of claim 15, wherein the measurement sequence further includes a second proximity measurement after the second calibration measurement and a third calibration measurement after the second proximity measurement; and
wherein the program instructions are further executable to:
determine the amount of light produced by the first light source and reflected from the object by averaging the first, second, and third calibration measurements and averaging the first and second proximity measurements.

17. The computer readable medium of claim 15, wherein the measurement sequence further includes a second proximity measurement after the second calibration measurement and a third calibration measurement after the second proximity measurement; and
wherein the program instructions are further executable to:
cause activation of a second light source during the second proximity measurement and not during the third calibration measurement.

18. The computer readable medium of claim 17, wherein the program instructions are further executable to:
determine an amount of light produced by the second light source and reflected from the object based on the second and third calibration measurements and the second proximity measurement.

19. The computer readable medium of claim 15, wherein the program instructions are executable by a processor to:
adjust periods of the first, second, and third measurements based on an amount of ambient light.

20. The computer readable medium of claim 15, wherein the first light source is enabled for a period between 10 μs and 50 μs.
